(19) United States
(12) Patent Application Publication
(10) Pub. No.: US 2012/0079931 A1
(43) Pub. Date: Apr. 5, 2012

(54) Track Saw System

(76) Inventor: Joel Hansen, Clear Lake, IA (US)

(21) Appl. No.: 13/249,434

(22) Filed: Sep. 30, 2011

Related U.S. Application Data
(60) Provisional application No. 61/404,326, filed on Oct. 1, 2010.

(51) Int. Cl. B23D 47/02

(52) U.S. Cl. 83/508.2

(57) ABSTRACT

A track saw system including a track having a pair of longitudinally-elongated rails extending along its top surface. Each rail has an angled sidewall extending from the top of the track at an angle of 45 degrees. The system further includes a base plate adapter having a pair of grooves formed in its bottom surface that are similar in size, shape, and relative position to the rails. The distance between the angled walls of the grooves is shorter than the distance between the angled walls of the rails. The rails of the track thus fit within the grooves of the base plate adapter with the angled sidewalls of the rails flatly engaging the angled sidewalls of the grooves. A firm, non-binding fit is thereby maintained between the track and the base plate adapter regardless of any expansion or contraction of the track that might occur due to variations in temperature.

### CROSS-REFERENCES TO RELATED APPLICATIONS

This application claims the benefit of U.S. Provisional Application No. 61/404,326 filed Oct. 1, 2010.

### STATEMENT REGARDING FEDERALLY-SPONSORED RESEARCH AND DEVELOPMENT

(Not Applicable)

### REFERENCE TO AN APPENDIX

(Not Applicable)

### BACKGROUND OF THE INVENTION

The present invention relates generally to the field of power tool guides and relates more particularly to a track saw system that does not bind or become loose regardless of manufacturing variations or any expansion or contraction of its track due to normal variations in temperature.

In the field of woodworking, it is often necessary to saw building materials, such as pieces of wood, along substantially straight lines to ensure a proper fit and/or alignment with other materials or structures. It can be very difficult to accomplish such a straight cut with a handheld circular saw or other handheld power tool that produces cuts that are generally only as straight as the skill and dexterity of the tool's operator allow. Even when provided with visual indicia, such as a straight line drawn on the surface of material that is to be cut, few individuals possess the skill necessary to guide a handheld tool precisely along the indicia to produce a substantially straight cut. This is particularly true in the case of lengthy cuts. In view of this difficulty, cutting guides (commonly referred to as edge guides) were developed soon after the advent of handheld circular saws to assist with making straight cuts. Such guides, and the advantages offered by them, are well-known to those of ordinary skill in the art.

The most common variety of edge guide employs a piece of rigid material, such as a length of wood or metal, having a straight edge. The guide is typically clamped to a piece of material that is to be cut, with the straight edge of the guide extending adjacent and parallel to a desired cut-line on the material. The blade of a circular saw is then passed along the desired cut-line while a side of the saw's base plate is kept in lateral contact with the guide. The guide thereby restricts lateral movement of the saw in one direction and facilitates a substantially straight cut.

One challenge that is commonly associated with conventional edge guides is correctly positioning the straight edge of such a guide on a piece of material to facilitate a cut precisely along a desired line. This is because the blade of a circular saw does not cut exactly along the edge of the guide, but along a line that is offset from the edge of the guide by several inches. Thus, to position the guide correctly, an operator must allow for an appropriate amount of offset between the edge of the guide and the actual cut-line of the saw blade when establishing the position of the edge guide. This can be a very tedious and cumbersome process, especially if there are a large number of cuts to be made.

Another challenge associated with conventional edge guide systems is that, while they work well for cutting wide pieces of material, they generally cannot be used for cutting narrow pieces of material. This is because a piece of material being cut must be at least wide enough to support both the edge guide and a circular saw in a side-by-side relationship during cutting. It is therefore difficult, and in some cases impossible, to use a conventional edge guide to cut pieces of material that are less than about 6 to 12 inches in width.

In order to address the above-described deficiencies of conventional edge guides, devices that are now commonly known as “track saws” were developed. A track saw generally comprises an elongated planar track that, during use, is positioned atop a piece of material that is to be cut. An elongated, rectangular rail extends from the top of the track. A circular saw that is used in conjunction with the track attaches to a base plate having a rectangular groove formed in it. The rectangular groove is adapted to receive and matingly engage the rail of the track. When the saw is placed on the track with the rail of the track engaging the groove in the base plate, the saw can be forcibly slid along the track in a substantially straight line with the engagement between the rail and the groove preventing lateral movement of the saw blade in either direction. The rail-groove engagement thereby facilitates a substantially straight cut.

An additional advantage of the track saw is that the saw blade of such a saw is aligned to cut through the track or, more preferably, through a replaceable strip of material that is attached to the edge of the track. The advantage of this configuration is that once the saw blade has passed through the replaceable strip, the cut edge of the strip will thereafter precisely define a line along which the saw blade will make its subsequent cuts. This greatly simplifies the task of positioning the track on a piece of material to be cut, as there is no need to compensate for an offset as one must do with an edge guide system.

The configuration of the track saw also facilitates the cutting of narrow pieces of material. Since the saw is positioned atop the track (as opposed to laterally adjacent the track, as in the case of an edge guide), the track can simply be placed atop a narrow piece of material with the edge of the track positioned exactly where a cut is to be made. If the piece of material is much shorter or narrower than the track, a piece of scrap material having substantially the same thickness as the material to be cut is preferably placed under the other end or edge of the track so that the track is evenly supported. The saw is then operated in the manner described above to cut the material.

A further advantage of the track saw is that it produces a cleaner, less ragged edge in the material being cut than conventional edge guide systems. This is because the teeth of a circular saw blade enter the bottom side of the piece of material being cut and exit the top side of the material at the front of the blade. Thus, if the top side of the material immediately adjacent the blade is unsupported, the material is likely to chip and splinter during cutting as the teeth pull up on the material as the blade exits the material. Such chipping and splintering is commonly associated with edge guide systems, wherein a saw blade is spaced apart from the edge of the guide, thus leaving the material that is being cut unsupported along the cut line. By contrast, a piece of material that is cut by a track saw system is usually supported along the entire cut line, as the saw blade of a track saw cuts through the material to be cut directly adjacent a replaceable strip of material that defines the edge of the track saw's guide and supports the material against the upward force applied by the blade. The material being cut therefore chips and splinters much less compared to a cut produced by an edge guide.

While track saws offer numerous advantages over previously developed cutting guide systems, track saws also present challenges and deficiencies of their own. For example, due to factors such as manufacturing tolerances and temperature-related expansion and contraction of materials, it is difficult to manufacture a track saw having a track rail and a base plate groove that will consistently engage one another in a close clearance relationship without binding. Conventional track saw rails are typically formed of aluminum, which expands and contracts significantly with temperature changes. Since track saws are often used in outdoor settings, such as at construction sites, the ambient temperature in the vicinity of a track saw can vary greatly depending on the season and the time of day. Thus, a track saw that slides freely and operates well on a cool day can bind and become useless on a hot, sunny day if high temperatures cause the track rail to expand. Alternatively, a track saw that operates well on a hot day could become prone to excessive lateral movement on a cool day if low temperatures cause the track rail to contract, resulting in the fit between the rail and the base plate groove of the saw becoming loose. Such excessive lateral movement can produce a poor, imprecise cut-line and can pose a safety hazard to an operator.

One solution to the problem of expansion and contraction of the track rail is to add a mechanism to the track saw's base plate that can adjust the width of the groove in order to accommodate the size of the rail. This solution has been found to work, but it significantly adds to the cost of a track saw system and requires frequent adjustment to maintain the system's accuracy. Establishing a close tolerance fit with such a system also makes the system more difficult to use, as the operator must place the saw on the track precisely, within a few thousandths of an inch over a 12″ long saw plate, in order to engage the track rail properly. This can be a very difficult task when holding a heavy circular saw in one hand.

In view of the forgoing, it would be advantageous to provide a track saw system having a base plate and a track that easily engage one another in a consistent manner to provide smooth, straight travel of the system's saw blade without binding or loosening due to temperature or manufacturing variations.

### BRIEF SUMMARY OF THE INVENTION

In accordance with the present invention, there is provided a track saw system that includes a track and a base plate adapter. The track is a substantially planar, rectangular member that is preferably formed of extruded aluminum. The track has a pair of longitudinally-elongated rails extending upwardly from its top surface in a laterally-spaced, parallel relationship. The rails are preferably located nearer one of the lateral edges of the track than the other, thus dividing the track into a laterally longer side adjacent one of the rails and a laterally shorter side adjacent the other rail.

The rails of the track are formed of three adjoining sidewalls. Each rail has an outer sidewall with an exterior surface that extends upwardly from the top surface of the track and inwardly at a preferred angle of 45 degrees. A gap between the opposing, inner sidewalls of the rails defines a rectangular stabilizing channel, the function of which will be described below.

A pair of replaceable edge strips that are preferably formed of plastic are removably affixed to the lateral edges of the track. The replaceable edge strips are substantially the same length as the track and extend laterally outwardly beyond the edges of the track. The lower portions of the edge strips are preferably coplanar with the bottom surface of the track.

The base plate adapter of the track saw system is preferably a substantially planar, rectangular body that is formed of ultra-high-molecular-weight polyethylene having a sufficiently low coefficient of friction for allowing the base plate adapter to easily slide along the top surface of the track. During use, the base plate adapter is mounted to the base plate of a conventional, handheld circular saw. A rectangular saw blade aperture is formed through the base plate adapter for allowing pass-through of the saw's blade.

A pair of longitudinally extending grooves are formed in the bottom surface of the base plate adapter in a laterally-spaced, parallel relationship. The size, shape, and position of the grooves are substantially similar to the size, shape, and position of the rails on the track. The dimensions of the grooves differ from those of the rails in that the distance between the angled sidewalls of the grooves is slightly less than the lateral distance between the angled sidewalls of the rails. The result of this difference in distance is that when the base plate adapter is mounted on the track, the angled surfaces of the outer sidewalls of the track flatly engage the angled surfaces of the outer sidewalls of the base plate adapter, thereby supporting the entire base plate adapter. This flat engagement is maintained regardless of manufacturing variations or expansion or contraction of the track or base plate adapter, such as may be caused by variations in ambient temperature.

The configuration of the inventive track saw system, and of the angled surfaces of the grooves and rails of the base plate adapter and the track in particular, prevents the engagement between the rails and the grooves from becoming excessively tight or excessively loose. Therefore, the base plate adapter will always ride smoothly atop the track without binding or excessive lateral movement.

In order to make a 90 degree cut with the track saw system, the base plate adapter, and a handheld circular saw affixed thereto, are mounted on a first longitudinal end of the track with the saw blade aperture extending over the laterally longer side of the track and with the saw blade positioned longitudinally adjacent, and laterally aligned with, a replaceable edge strip of the track. The activated saw is then slid longitudinally along the length of the track with the saw blade trimming the replaceable edge strip. Thereafter, the trimmed edge of the replaceable edge strip indicates a precise line through which the saw blade will cut in subsequent passes. Therefore, when cutting a piece of material, an operator need only align the trimmed edge with the desired cut-line before making a pass with the saw blade.

In order to make a beveled cut with the track saw system, wherein the blade of the circular saw is tilted with its lower edge shifted inwardly, toward the track, the base plate adapter and saw are mounted atop the track with the saw blade aperture extending over the laterally shorter side of the track. The saw blade is thereby shifted laterally further away from the track relative to the 90 degree cut configuration described above, thus allowing the inwardly-shifted, lower edge of the saw blade to properly align with the replaceable edge strip of the track. With the base plate adapter mounted thusly, the replaceable edge strip can be trimmed and a piece of material can be cut in substantially the same manner as described above.

### BRIEF DESCRIPTION OF THE SEVERAL VIEWS OF THE DRAWINGS

FIG. 1 is a right-side perspective view illustrating the preferred embodiment of the present invention.

FIG. 2 is a left-side perspective view illustrating the preferred embodiment of the present invention shown in FIG. 1.

FIG. 3 is a top perspective view illustrating the preferred embodiment of the present invention shown in FIG. 1.

FIG. 4 is a view in section illustrating the preferred embodiment of the present invention shown in FIG. 1 with the track expanding.

FIG. 5 is a view in section illustrating the preferred embodiment of the present invention shown in FIG. 1 with the track contracting.

FIG. 6 is a left-side perspective view illustrating the preferred embodiment of the present invention shown in FIG. 1 in a 90 degree cut configuration.

FIG. 7 is a right-side perspective view illustrating the preferred embodiment of the present invention shown in FIG. 1 in a beveled cut configuration.

FIG. 8 is a perspective view illustrating a first alternative embodiment of the present invention.

FIG. 9 is a perspective view illustrating a second alternative embodiment of the present invention.

FIG. 10 is a perspective view illustrating a third alternative embodiment of the present invention.

FIG. 11 is a perspective view illustrating a fourth alternative embodiment of the present invention.

In describing the preferred embodiment of the invention which is illustrated in the drawings, specific terminology will be resorted to for the sake of clarity. However, it is not intended that the invention be limited to the specific term so selected and it is to be understood that each specific term includes all technical equivalents which operate in a similar manner to accomplish a similar purpose

### DETAILED DESCRIPTION OF THE INVENTION

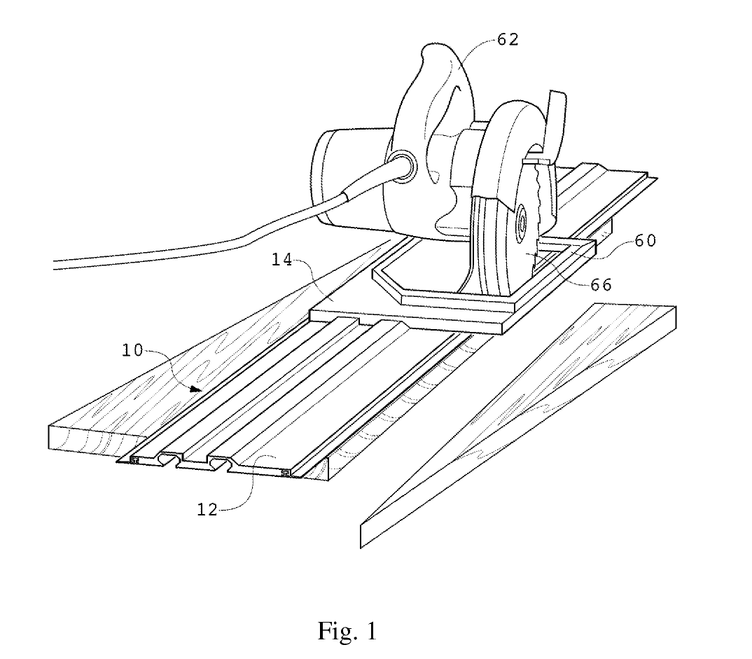

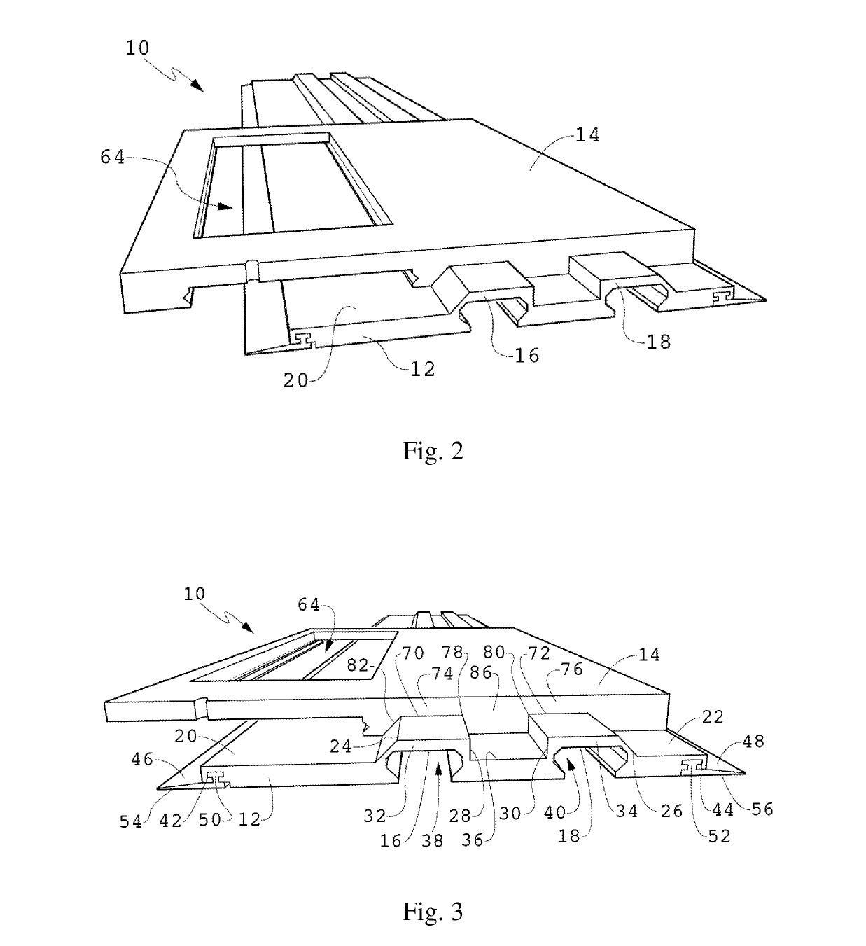

Referring to FIGS. 1-5, an improved track saw system, indicated generally at 10, is shown. The track saw system 10 generally includes a track 12 and a circular saw base plate adapter 14. For the sake of convenience and clarity, terms such as “top,” “bottom,” “inward,” “outward,” “length,” “width,” “lateral,” and “longitudinal” will be used herein to describe the relative size and orientation of various components of the invention, all with respect to the geometry and orientation of the track and the base plate adapter as they appear in FIGS. 1 and 2. This terminology will include the words specifically mentioned, derivatives thereof, and words of similar import.

The track 12 of the improved system 10 is preferably formed of extruded aluminum, although it is contemplated that the track 12 can be formed of a variety of other suitably rigid, durable, and preferably lightweight materials, including, but not limited to, steel, wood, plastic, and various composites. The track 12 is substantially planar and is rectangular in shape with a preferred length of about 57 inches, a preferred width of about 5.7 inches, and a preferred height of about 0.5 inches. It is contemplated that the track 12 can be made longer or shorter, wider or narrower, or taller or shorter than the stated dimensions without departing from the present invention.

Referring to FIGS. 2 and 3, two longitudinally-elongated rails 16 and 18 extend upwardly from the top surface of the track 12 in a laterally-spaced, parallel relationship. The rails 16 and 18 are located nearer one of the lateral edges of the track 12 (for reasons that will be described below), thus dividing the track 12 into a laterally longer side 20, hereafter referred to as the perpendicular-cut side 20, and a laterally shorter side 22, hereafter referred to as the angled-cut side 22. The rails 16 and 18 are substantially identical to one another in size and shape, but are reversed with regard to orientation. The rail 18 is therefore a mirror image of the rail 16 across an imaginary, vertical plane located intermediate the rails 16 and 18.

The rails 16 and 18 have outer sidewalls 24 and 26 with exterior surfaces that extend upwardly from the top surface of the track 12 and inwardly at an angle of 45 degrees, inner sidewalls 28 and 30 with exterior surfaces that are perpendicular to the top surface of the track 12, and top walls 32 and 34 with exterior surfaces that are parallel to the top surface of the track 12. The gap between the opposing, inner sidewalls 28 and 30 of the rails 16 and 18 defines a rectangular stabilizing channel 36 (described in greater detail below). The interior surfaces of the walls 24-34 of the rails 16 and 18 also define longitudinally-extending grooves 38 and 40 below the rails 16 and 18 that extend downwardly through the track 12. Those of ordinary skill in the art will recognize that the grooves 38 and 40 are intended to receive a self-aligning connecting device that allows a user to extend the length of the track 12 by appending an additional length of track that is similar to the track 12. It is contemplated that these grooves 38 and 40 could alternatively be used to receive accessories such as a clamping mechanism to attach the track 12 to a board, or a squaring or measuring device, or could be solid material that is contiguous with the rest of the track 12.

The track 12 has a pair of longitudinally-elongated, T-shaped mounting channels 42 and 44 that extend through the track 12 adjacent the track's lateral edges. Longitudinally-elongated, replaceable edge strips 46 and 48 having T-shaped mounting rails 50 and 52 are removably mounted in the T-shaped channels 42 and 44 by sliding the rails 50 and 52 longitudinally into the channels 42 and 44, respectively. The replaceable edge strips 46 and 48 are substantially the same length as the track 12 and have lip portions 54 and 56 that, when the edge strips 46 and 48 are operatively mounted to the track 12, extend laterally outwardly beyond the edges of the track 12 a distance of about 1 inch. The bottom surfaces of the edge strips 46 and 48 are substantially coplanar with the bottom surface of the track 12.

The upper portions of the replaceable edge strips 46 and 48 are preferably formed of rigid plastic, although it is contemplated that the edge strips 46 and 48 can alternatively be formed of any suitably rigid material that will not damage or significantly dull a saw blade that cuts through the edge strips 46 and 48, including, but not limited to, wood, plastic, and various composites. The lower portions of the edge strips 46 and 48 are preferably formed of a softer plastic having a sufficiently high coefficient of friction to prevent slippage when the track is placed on a piece of material to be cut, but this is not critical. It is contemplated that the edge strips 46 and 48 can be removably mounted to the edges of the track 12 using a variety of alternative means, including, but not limited to, conventional mechanical fasteners, adhesives, or snap fit. Still further, it is contemplated that the lip portions 54 and 56 of the edge strips 46 and 48 can extend outwardly at a slight downward angle from bottom surface of the track 12 for providing increased downward pressure on a piece of material being cut to further mitigate chipping and splintering as further described below.

Still referring to FIGS. 2-3, the base plate adapter 14 is preferably a substantially planar, rectangular, unitary body that is formed of ultra-high-molecular-weight polyethylene (UHMWPE). It is contemplated that the base plate adapter 14 can alternatively be formed of any other material that is sufficiently wear-resistant and that has a sufficiently low coefficient of friction for allowing the base plate adapter 14 to easily slide along the surface of the track 12 through the application of moderate manual force by an operator (as described below). Such materials include numerous thermoplastics that will be familiar to those of ordinary skill in the art. The base plate adapter 14 has a preferred length of about 13 inches, a preferred width of about 7.5 inches, and a preferred height of about 0.5 inches, although it is contemplated that the base plate adapter 14 can be made longer or shorter, wider or narrower, or taller or shorter than the stated dimensions without departing from the present invention.

During use, the base plate adapter 14 is mounted to the base plate of a conventional, handheld circular saw, such as the base plate 60 of the circular saw 62 shown in FIG. 1. The base plate adapter 14 is preferably fastened to the base plate 60 using conventional, removable fasteners, such as screws (not shown), that extend through axially aligned apertures in the base plate adapter 14 and the base plate 60. A rectangular saw blade aperture 64 (best shown in FIGS. 2 and 3) is formed through the base plate adapter 14 adjacent a lateral edge of the base plate adapter 14 and provides a vertical pass-through for the saw blade 66 of the circular saw 62. The saw blade aperture 64 preferably measures about 10 inches by about 2.75 inches, as it has been found that these dimensions match those of the saw blade apertures of the base plates of most commercially available, handheld circular saws and do not interfere with the function of existing blade guards. Matching the dimensions of the saw blade aperture 64 to the saw blade aperture of a circular saw's conventional base plate facilitates alignment of the edges of the saw blade aperture 64 with those of the saw blade aperture of the circular saw's conventional base plate, which in-turn simplifies the eventual alignment of a saw's blade relative to a piece of material that is to be cut. However, it is contemplated that the saw blade aperture 64 can be made smaller or larger without departing from the invention.

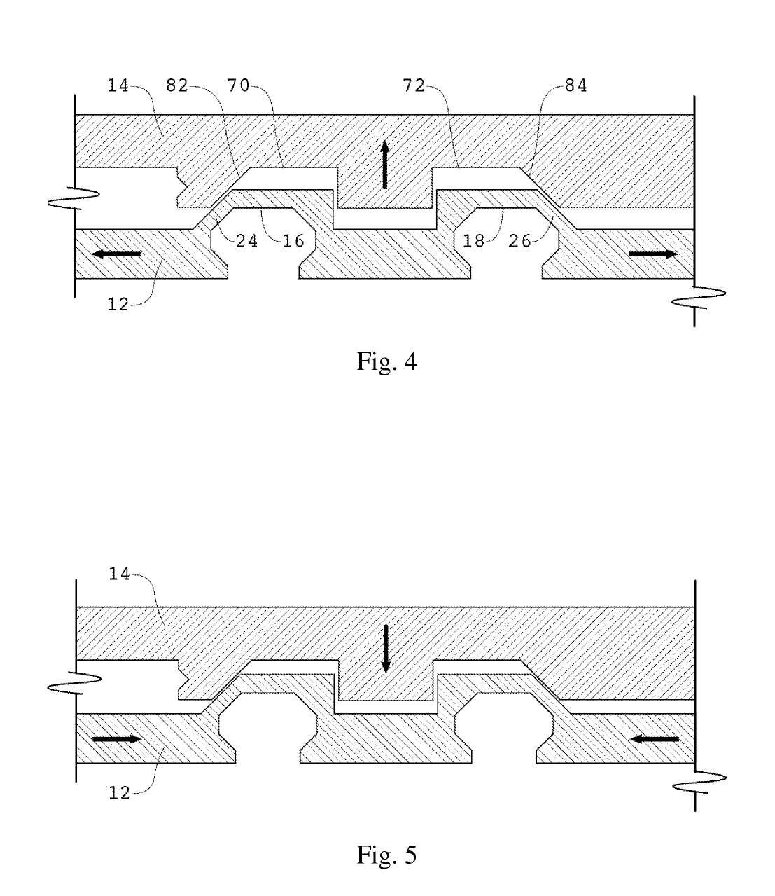

Referring to FIGS. 2 and 3, two longitudinally-extending grooves 70 and 72 are formed in the bottom surface of the base plate adapter 14 in a laterally-spaced, parallel relationship in substantially the same manner as the above-described rails 16 and 18 of the track 12. The size, shape, and position of the grooves 70 and 72 are substantially similar to the size, shape, and position of the rails 16 and 18. Particularly, the grooves 70 and 72 have top walls 74 and 76 with horizontally-oriented surfaces, inner sidewalls 78 and 80 with vertically-oriented surfaces, and the angled, outer sidewalls 82 and 84 (sidewall 84 is shown in FIG. 4) with surfaces that extend upwardly and inwardly from the bottom surface of the base plate adapter 14 at an angle of 45 degrees. The opposing, inner walls of the grooves 70 and 72 define a rectangular rail, hereafter referred to as the catch 86 (described in greater detail below), therebetween.

Referring to FIGS. 4 and 5, the grooves 70 and 72 of the base plate adapter 14 differ in dimension from the rails 16 and 18 of the track 12 in that the distance between the outer lateral edges of the top walls 74 and 76 of the grooves 70 and 72 is slightly less than the distance between the outer lateral edges of the top walls 32 and 34 of the rails 16 and 18. For example, in the preferred embodiment of the invention shown in FIGS. 2 and 3, the distance between the outer lateral edges of the top walls 74 and 76 of the grooves 70 and 72 is 2.480 inches and the distance between the outer lateral edges of the top walls 32 and 34 of the rails 16 and 18 is 2.500 inches. The result of this difference in the overall width of the top walls 32 and 34 of the rails 16 and 18 relative to the top walls 74 and 76 of the grooves 70 and 72 is that when the base plate adapter 14 is operatively mounted on the track 12 (as further described below), the angled surfaces of the outer sidewalls 24 and 26 of the track 12 supportively engage the angled surfaces of the outer sidewalls 82 and 84 of the base plate adapter 14 and thereby support the entire base plate adapter 14. The longitudinal surfaces (i.e. the bottom surface of the base plate adapter 14 and the bottom surfaces of the top walls 74 and 76 of the grooves 70 and 72) of the base plate adapter 14 float above, and do not engage, the longitudinal surfaces (i.e. the top surface of the track 12 and the top surfaces of the top walls 32 and 34) of the track 12. The flat engagement between the angled surfaces of the sidewalls 82 and 84 and the angled surfaces of the sidewalls 24 and 26 is maintained regardless of any expansion or contraction of the track 12 or base plate adapter 14, such as may be caused by variations in ambient temperature. “Flat engagement” is defined herein to mean substantially continuous, surface-to-surface contact of one planar surface to another planar surface.

For example, referring to FIG. 4, wherein the width of the track 12 has expanded due to an increase in the temperature of the track 12, flat engagement is nevertheless maintained between the angled surfaces of the sidewalls 82 and 84 of the grooves 70 and 72 and the angled surfaces of the sidewalls 24 and 26 of the rails 16 and 18. The lateral expansion of the track 12 has merely forced the angled surfaces of the sidewalls 82 and 84 to slide upwardly along the outwardly-shifting, angled surfaces of the sidewalls 24 and 26, perpendicular to the direction of the track's expansion, thereby causing the base plate adapter 14 to ride slightly higher on the rails 16 and 18 relative to when the track 12 was cooler and narrower (as shown in FIG. 3). Importantly, the lateral position of the base plate adapter 14 relative to the track 12 does not change as the track 12 expands.

Referring now to FIG. 5, wherein the width of the track 12 has contracted due to a decrease in the temperature of the track 12, flat engagement is nevertheless maintained between the angled surfaces of the sidewalls 82 and 84 of the grooves 70 and 72 and the angled surfaces of the sidewalls 24 and 26 of the rails 16 and 18. The lateral contraction of the track 12 has simply caused the angled surfaces of the sidewalls 82 and 84 to slide downwardly along the inwardly-shifting, angled surfaces of the sidewalls 24 and 26, perpendicular to the direction of the track's contraction, thereby causing the base plate adapter 14 to ride slightly lower on the rails 16 and 18 relative to when the track 12 was warmer and wider (as shown in FIG. 4). Again, the lateral position of the base plate adapter 14 relative to the track 12 has not changed.

The configuration of the rails 16 and 18 and grooves 70 and 72 of the track saw system 10, and the configuration of the opposing, angled sidewalls 24, 26, 82, and 84 of the rails 16 and 18 and the grooves 70 and 72 in particular, prevents the engagement between the rails 16 and 18 and the grooves 70 and 72 from becoming excessively tight or excessively loose as a result of expansion or contraction of the track 12. The angled surfaces of the sidewalls 82 and 84 of the grooves 70 and 72 will simply ride higher or lower on the angled surfaces of the sidewalls 24 and 26 of the rails 16 and 18. This ensures that the base plate adapter 14 will always ride smoothly atop the track 12 without binding or excessive lateral movement regardless of variations in ambient temperature. Thus, the lateral position of a blade of a circular saw that is mounted to the base plate adapter 14 (as will be described in greater detail below) will always be the same relative to the track 12 regardless of variations in ambient temperature.

A further advantage of the configuration of the grooves 70 and 72 and the rails 16 and 18 of the inventive track saw system 10 is that it very easy to mount the base plate adapter 14 on the track 12 relative to conventional track saw systems. Conventional systems typically employ close fitting rectangular rails and grooves that require very precise alignment by an operator, sometimes to within several thousandths of an inch, to achieve engagement. By contrast, the open bottoms of the grooves 70 and 72 of the base plate adapter 14 are significantly larger than, and therefore easily accommodate, the relatively narrow tops of the rails 16 and 18 of the track 12. An operator is therefore provided with a wide, lateral margin wherein the grooves 70 and 72 will fit over the rails 16 and 18. Once the operator has successfully placed the bottoms of the grooves 70 and 72 over the tops of the rails 16 and 18, the operator can simply drop the base plate adapter 14 onto the track 12 with the angled surfaces of the grooves 70 and 72 automatically shifting into flush engagement with the angled surfaces of the rails 16 and 18. Thus, the angled surfaces guide the base plate adapter 14 to the correct position on the track 12.

While it is preferred that the surfaces of the angled sidewalls 24, 26, 82 and 84 of the grooves be oriented at an angle of 45 degrees in the manner described above, it is contemplated that orientation of the angled surfaces of the sidewalls 24, 26, 82, and 84 can be varied without departing from the present invention. Particularly, it is contemplated that the angled surfaces of the sidewalls 24, 26, 82, and 84 can be oriented at any angle in a range of about 10 degrees to about 80 degrees.

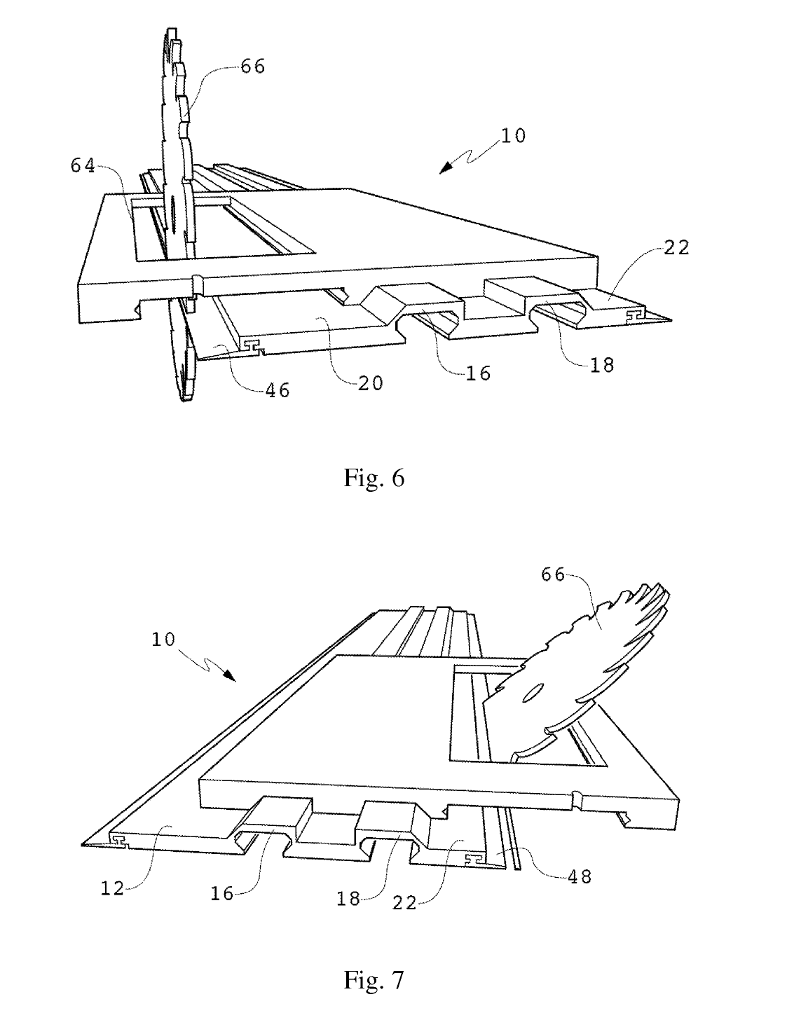

During typical operation of the track saw system 10, the base plate adapter 14 is first fastened to the base plate 60 of a handheld circular saw 62. The saw 62 and base plate adapter 14 are then mounted on a first longitudinal end of the track 12, with the saw blade aperture 64 extending over the perpendicular-cut side 20 of the track 12 (as shown in FIG. 2), and with the saw blade 66 positioned longitudinally adjacent, and laterally aligned with, the replaceable edge strip 46 of the track 12. The saw 62 is then activated and the saw 62 and base plate adapter 14 are manually slid longitudinally along the track 12, with the saw blade 66 trimming the replaceable edge strip 46 as shown in FIG. 6 (only the blade 66 of the saw 62 is shown for the sake of clarity).

Once the replaceable edge strip 46 has been trimmed, the new, exposed outer edge of the replaceable edge strip 46 indicates a precise cut-line through which the saw blade 66 will make subsequent passes. Thus, to make a desired cut in a piece of material, the track 12 is simply placed on the piece of material with the trimmed edge of the replaceable edge strip 46 extending along a desired cut-line. The saw 62 and base plate adapter 14 are then mounted on the track 12 and the saw 62 is activated. The saw 62 and base plate adapter 14 are then slid longitudinally along the track 12, with the saw blade 66 cutting the material precisely along the trimmed edge of the replaceable edge strip 46.

The trimming and cutting process described above is suitable for making 90 degree cuts (i.e. cuts with the blade oriented along a plane that is perpendicular to the base plate adapter 14) in a piece of material. However, the blades of most commercially available, handheld circular saws can be tilted to produce beveled cuts of less than 90 degrees, even to 45 degrees or less. Tilting the blade of a circular saw in such a manner typically results in the lower edge of the blade shifting laterally inwardly. With the track 12 saw system configured as shown in FIG. 6, such an inward shift of the blade 66 could result in the blade engaging the track 12 (as opposed to the replaceable edge strip 46). Such engagement would damage the track 12 and possibly also the blade 66.

Therefore, in order to facilitate a beveled cut, the position of the saw blade 66 must be shifted laterally, further away from the track 12 relative to the 90 degree cut configuration, so that the inwardly shifted saw blade 66 does not engage the metal body of the track 12. Such a shift is facilitated by the laterally-offset configuration of the rails 16 and 18 (i.e. being nearer one lateral edge of the track 12 than the other lateral edge). Specifically, in order to make a beveled cut, the saw 62 and the base plate adapter 14 are mounted on the track 12 with the saw blade aperture 64 extending over the shorter, angled-cut side 22 of the track 12, as shown in FIG. 7 (only the blade 66 of the saw 62 is shown for the sake of clarity). In order to achieve this configuration, the catch 86 is located exactly halfway between the angled walls 82 and 84 of the grooves 70 and 72 and the channel 36 is located exactly halfway between the angled walls 24 and 26 of the rails 16 and 18.

Mounted thusly, the tilted saw blade 66 is positioned laterally further from the track 12 relative to the 90 degree mounting configuration, and the lower end of the blade 66 properly engages the replaceable edge strip 48 of the track 12. The replaceable edge strip 48 can thus be trimmed with the first pass of the blade 66, and a piece of material can be aligned to the trimmed strip 48 and cut in substantially the same manner as described above. Alternative embodiments of the track 12 saw system are contemplated that do not facilitate beveled cutting, wherein the rails 16 and 18 of the track 12 are not offset in the manner described above.

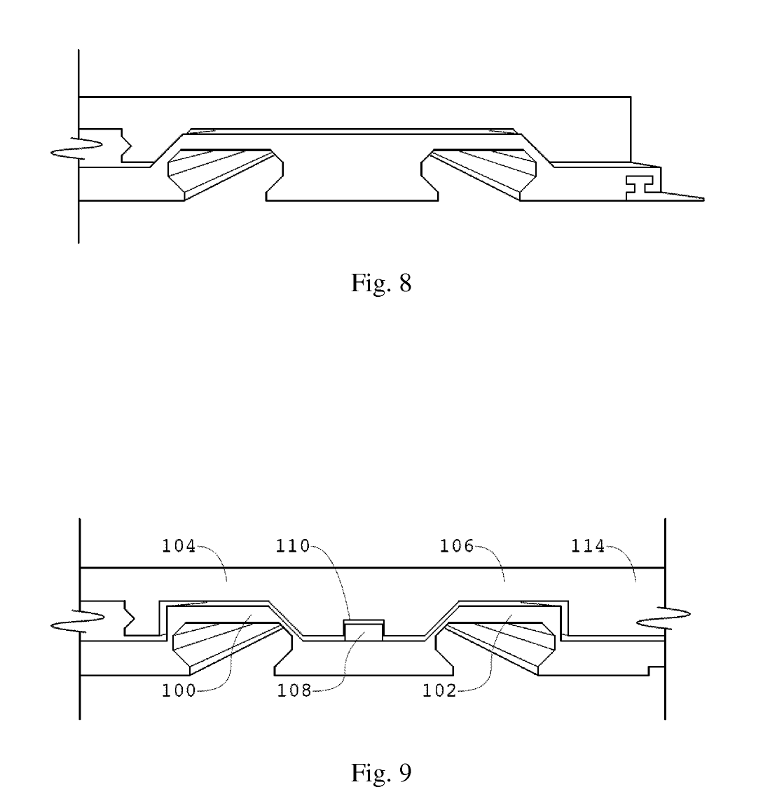

Mounting the base plate adapter 14 in the above-described, beveled-cut configuration results in a significant lateral shift of the center of gravity of the base plate adapter 14 (and the attached saw) away from the supporting track 12. This shift promotes instability in the track saw system 10 due to the weight of the saw 62 being shifted. The catch 86 and the stabilizing channel 36 (described above) are provided to mitigate such instability. The mating engagement between the rectangular catch 86 of the base plate adapter 14 and the rectangular stabilizing channel 36 of the track 12, and particularly the lateral engagement between the sidewalls of the catch 86 and the sidewalls of the stabilizing channel 36, prevent the base plate adapter 14 and the saw from rocking excessively or falling off of the track 12, especially in the bevel cut configuration. While the catch 86 and the stabilizing channel 36 are important for this purpose, embodiments of the track 12 saw system are contemplated wherein the catch 86 and the stabilizing channel 36 are omitted. Such an embodiment is shown in FIG. 8.

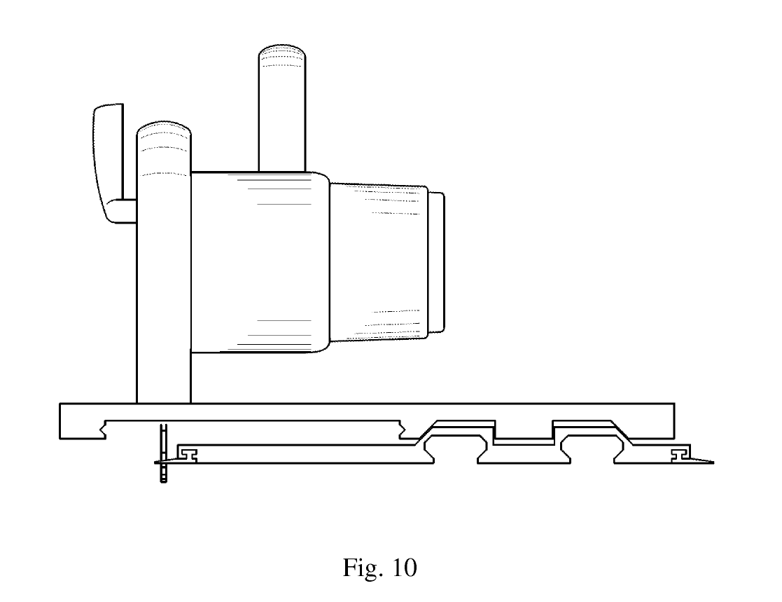

It will be understood by those of ordinary skill in the art that position and orientation of the rails 16 and 18, the grooves 70 and 72, the catch 86, and the stabilizing channel 36 of the track saw system 10 can be varied without departing from the present invention. For example, referring to FIG. 9, the orientations of the rails 100 and 102 and the grooves 104 and 106 are reversed relative to the preferred embodiment of the invention, with the catch 108 extending from the track 112 into a stabilizing channel 110 in the base plate adapter 114.

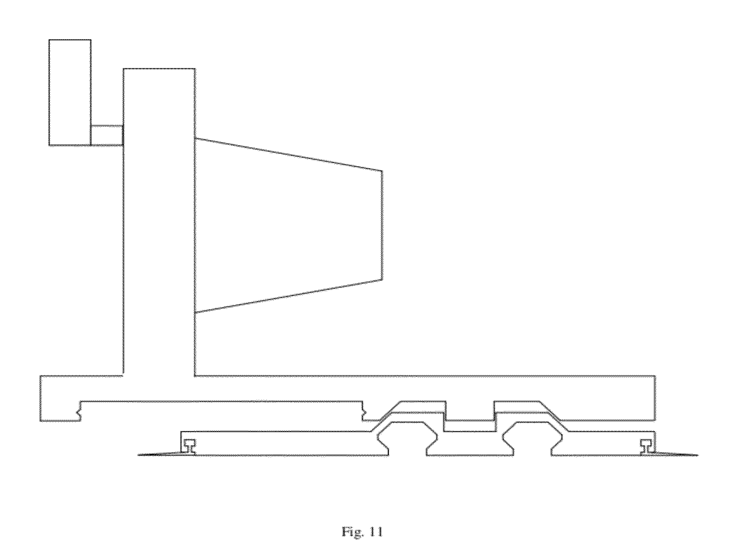

In another alternative embodiment, the track saw system shown in FIG. 10 is similar to the alternative system shown in FIG. 9 except that the catch 200 extends downwardly from the angled sidewalls 202 and 204 of the grooves 206 and 208.

A further embodiment of the inventive track saw system 10 is contemplated in which grooves are formed in the track 12 (instead of in the base plate adapter 14) and corresponding rails are formed on the base plate adapter 14 (instead of on the track 12).

It is further contemplated that the entire base plate adapter 14, including all of the features and alternative embodiments of the base plate adapter 14 described above, can be integrated into the structure of a handheld circular saw. Such a circular saw would be mounted directly onto the track of the inventive track saw system without a separate, intermediate component, as shown in FIG. 11. The term “base plate adapter,” as used herein, can therefore refer to both an intermediate component that is mounted to the existing base plate of a conventional circular saw for facilitating engagement with a track, or to a base plate that is integral with a circular saw and that has been adapted to directly engage a track as described above. Many other alternative embodiments of the track saw system 10 are contemplated but are not shown or described herein.

This detailed description in connection with the drawings is intended principally as a description of the presently preferred embodiments of the invention, and is not intended to represent the only form in which the present invention may be constructed or utilized. The description sets forth the designs, functions, means, and methods of implementing the invention in connection with the illustrated embodiments. It is to be understood, however, that the same or equivalent functions and features may be accomplished by different embodiments that are also intended to be encompassed within the spirit and scope of the invention and that various modifications may be adopted without departing from the invention or scope of the following claims.

1. A track saw system having a track portion and a base plate adapter portion, the track saw system comprising:
a) first and second elongated rails extending from a surface of a first one of the portions in a parallel, laterally-spaced relationship, wherein the first rail has a first angled surface that extends from the surface of the first portion at a predetermined angle, the second rail has a second angled surface that extends from the surface the first portion at a predetermined angle, and wherein the orientation of the first angled surface is reversed relative to the orientation of the second angled surface; and
b) first and second elongated grooves formed in a surface of a second one of the portions in a parallel, laterally-spaced relationship, wherein the first groove has a first angled surface that extends from the surface of the second portion at a predetermined angle, the second groove has a second angled surface that extends from the surface of the second portion at a predetermined angle, and wherein the orientation of the first angled surface is reversed relative to the orientation of the second angled surface, and wherein a distance between the first and second angled surfaces of the grooves is shorter than a distance between the first and second angled surfaces of the rails;
wherein, during operation of the track saw system, the rails fit within the grooves and the first and second angled surfaces of the rails flatly engage and support the first and second angled surfaces of the grooves.

2. The track saw system in accordance with claim 1, wherein the first and second rails extend from the surface of the track portion and the first and second grooves are formed in the surface of the base plate adapter portion.

3. The track saw system in accordance with claim 1, wherein the first angled surface of the first rail is substantially a minor image of the second angled surface of the second rail about a plane therebetween, the first angled surface of the first groove is substantially a mirror image of the second angled surface of the second groove about a plane therebetween, the first angled surface of the first rail is substantially parallel to the first angled surface of the first groove, and the second angled surface of the second rail is substantially parallel to the second angled surface of the second groove.

4. The track saw system in accordance with claim 1, further comprising a replaceable edge strip removably mounted to at least one lateral edge of the track portion.

5. The track saw system in accordance with claim 4, further comprising first and second replaceable edge strips removably mounted to opposing lateral edges of the track portion.

6. The track saw system in accordance with claim 1, further comprising a longitudinally-elongated catch extending from a surface of one of portions and a longitudinally-elongated stabilizing channel formed in the other of the portions, wherein the catch matingly engages the stabilizing channel in a close clearance relationship.

7. The track saw system in accordance with claim 1, wherein the rails are located nearer a first lateral edge of one of the portions and further from a second, opposing lateral edge of that portion.

8. The track saw system in accordance with claim 1, wherein the angled surfaces of the rails and the grooves extend from the surfaces of the portions at an angle in a range of about 10 degrees to about 80 degrees.

9. The track saw system in accordance with claim 8, wherein the angled surfaces of the rails and the grooves extend from the surfaces of the portions at an angle in a range of about 30 degrees to about 60 degrees.

10. The track saw system in accordance with claim 9, wherein the angled surfaces of the rails and the grooves extend from the surfaces of the portions at an angle in a range of about 40 degrees to about 50 degrees.

11. The track saw system in accordance with claim 1, wherein the base plate adapter portion is separate from a base of a saw.

12. The track saw system in accordance with claim 1, wherein the base plate adapter portion is integral with a base of a saw.
